(19) United States
(12) Patent Application Publication
(10) Pub. No.: US 2004/0111628 A1
(43) Pub. Date: Jun. 10, 2004

(54) Information output apparatus, information output method and information output program

(75) Inventors: Hirokazu Inotani, Tokorozawa-shi (JP); Takashi Tsuneshige, Tokorozawa-shi (JP); Masato Hiratsuka, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/665,413

(22) Filed: Sep. 22, 2003

(30) Foreign Application Priority Data
Sep. 20, 2002 (JP) P2002-276384

(51) Int. Cl. H04L 9/00; G06F 17/60

(52) U.S. Cl. 713/189; 705/57

(57) ABSTRACT

To provide an information output apparatus in which even when the output of an isochronous packet containing the audio information or the like is suspended and restarted, the process for the audio information or the like can be quickly resumed and the occurrence of the headless state of the audio information after resumption of the process can be prevented.

In an information output apparatus for outputting an isochronous packet containing the audio information and the sync information, it is determined whether the audio information is output or not (step S1), and when the audio information is not output, a soundless packet containing the fixed value information having a preset fixed value replacing the audio information and the control information is output (steps S9, S11)

### BACKGROUND OF THE INVENTION

1. Field of the Invention

The present invention relates to a technical field of an information output apparatus, an information output method and an information output program, or more in particular to a technical field of the information output apparatus for outputting the image information or the audio information outside, an information output method, and an information output program for the information output apparatus.

2. Description of the Related Art

In recent years, what is called IEEE1394 standard has been widely applied as a standard of a method for connecting an information reproducing apparatus such as a player for reproducing the audio information recorded in an optical disk, for example, and an amplifier unit (what is called an amplifier) for amplifying the reproduced audio information and outputting it to a speaker or the like.

The IEEE1394 standard is officially referred to as ‘IEEE Std. 1394-1995 IEEE Standard for a High Performance Serial Bus’, which is a standard used when the information reproducing apparatus and the amplifier are connected to each other by a serial bus constituted of a wire.

Next, an outline of the IEEE1394 standard will be explained in general terms. The IEEE1394 standard (hereinafter referred to simply as the serial bus standard) stipulates that a plurality of types of information processing apparatuses (hereinafter referred to simply as nodes) including the information reproducing apparatus and the amplifier described above are connected to each other by a serial bus, and information of a plurality of channels is transmitted between the nodes by time division. Hereat, according to this serial bus standard, a maximum of 63 different channels can be used for information transmission within the same series connected by a series of serial bus systems which do not include any branches.

Also, according to the serial bus standard, the information from the nodes is transmitted collectively in units called the isochronous cycle (where ‘cycle’ indicates one cycle formed by time division on the serial bus). The isochronous cycle includes an isochronous transmission area containing the information (specifically, the image information, the audio information, etc.) transmitted in synchronism with the information contained in other isochronous cycles and an asynchronous transmission area containing the information (specifically, the control information for controlling the output, etc. of the image information or the audio information) transmitted asynchronously without regard to other information. The information existing in the isochronous transmission area is divided by time for each different channel so that different information is transmitted for each channel.

Next, the information sent out from each node is transmitted on the serial bus. More specifically, the information from each node is transmitted on the serial bus while occupying it by time division. Each information thus is transmitted by being inserted in the isochronous cycle providing a synchronization unit 125 μm long on the serial bus.

Each isochronous cycle is configured of an isochronous transmission area included in a cycle start packet inserted always at the head of the isochronous cycle to set the reference time of all the nodes and an isochronous packet with a plurality of channels of temporally synchronous information included therein on the one hand, and an asynchronous transmission area containing asynchronous information (such as various control information and response information corresponding to each control information).

Further, each isochronous packet includes an IP (isochronous packet) header containing the information indicating the data amount in the particular isochronous packet, the sync information for controlling the synchronized state of the nodes to transmit and receive isochronous packets or the information indicating the channel for transmitting the information in each isochronous packet, and a data area containing actual audio information.

According to the aforementioned serial bus standard, the control information is transmitted at high speed from an information processing apparatus such as a personal computer. In this way, the electric home appliances and audio/visual devices such as an information reproducing apparatus can be centrally controlled. At the same time, the audio information or the like can be accurately transmitted between the nodes.

Here, let us return to the case in which the information reproducing apparatus and the amplifier are connected to each other by a serial bus according to IEEE 1394 standard. During the period when the audio information or the like is actually output from the information reproducing apparatus, the particular audio information or the like is transmitted contained in the isochronous packet. When the audio information or the like ceases to be output upon completion of the reproduction process of the information reproducing apparatus, however, the conventional configuration is such that the output of the very isochronous packet from the information reproducing apparatus is stopped or that only what is called the header information in the isochronous packet is output. Once the reproduction of the audio information or the like is completed, therefore, the synchronous information otherwise to be contained in the IP header also ceases to be output.

In the aforementioned conventional configuration, upon complete reproduction of the audio information or the like in the information reproducing apparatus, the output such as the sync information in the IP header otherwise to be contained in the isochronous packet also stops. As a result, the synchronized state thus far maintained between the information reproducing apparatus and the amplifier using the sync information is undesirably eliminated.

Under this condition, assume that the reproduction of the audio information or the like is resumed by the information reproducing apparatus. Before the sync information is transmitted from the information reproducing apparatus to the amplifier together with the reproduced audio information or the like and further the synchronized state is established for the amplifier using the synchronous information thus transmitted, the process for receiving the audio information or the like transmitted and the process for reproducing the audio information or the like following the receiving process are not started.

In such a case, the receiving and other processes in the amplifier are not started in spite of the fact that the audio information or the like is output from the information reproducing apparatus as isochronous packets. Consequently, the problem has been posed that the audio information or the like output from the amplifier is output to the speaker or the like in a ‘headless’ state as compared with the original form of the audio information or the like (output from the information reproducing apparatus) to be reproduced.

### SUMMARY OF THE INVENTION

This invention has been achieved in view of this problem, and an object thereof is to provide an information output apparatus, an information output method and an information output program, wherein even when an isochronous packet containing the audio information or the like is output again upon resumption of the interrupted reproducing operation, the process for amplifying the particular audio information or the like can be quickly restarted, and the audio information or the like can thus be output in such a manner as to prevent the occurrence of the headless state of the audio information or the like after resumption of the amplification and other processes.

The above object of the present invention can be achieved by an information output apparatus. The information output apparatus is provided with: a generating device for generating output information; an output device for generating and outputting information packets containing the generated output information and the control information used for processing the generated output information outside; and an output control device for controlling the output device in such a manner as to output the information packets containing the fixed value information having a fixed value preset in place of the output information when the output information is not generated by the generating device.

According to the information output apparatus, the information packets containing the fixed value information and the control information are output in place of the information packets containing the generated output information and the control information even when the output information is not generated. Thus, the same state as when the control information in the information packet is output can be maintained and sustained when the output information is not generated. When the information packets containing the output information are output again, therefore, the appropriate process for the audio information is quickly resumed at the output destination.

In one aspect of the information output apparatus, the information output apparatus further comprises: an encryption device for encrypting the output information; and a prohibition device for prohibiting the execution of the encryption process of the encryption device for the fixed value information when the output information is not generated by the generating device.

According to this aspect, when the output information is not generated, the information packets output with the encryption prohibited, the encryption process for the fixed value information easy to decrypt is not executed. Thus, the confidentiality of the encryption process for the audio information can be secured.

In another aspect of the information output apparatus, the information output apparatus further comprises an acquisition device for acquiring the copyright information for the output information, wherein the encryption device encrypts the generated output information when the acquired copyright information indicates that the generated output information should be protected by the copyright.

According to this aspect, since the encryption device encrypts the generated output information when the acquired copyright information indicates that the generated output information should be protected by the copyright, the copy protection for the generated output information can be secured with reliability.

In further aspect of the information output apparatus, wherein the output information is audio information and the fixed value of the fixed value information is zero.

According to this aspect, since the fixed value of the fixed value information is 0, the state can be maintained through a simple process during the output of the generated output information.

In further aspect of the information output apparatus, wherein the control information is sync information used to form the synchronous state of the information packets at the output destination.

According to this aspect, since the control information is the sync information, the synchronized state can be maintained through a simple process during the output of the generated output information.

In further aspect of the information output apparatus, wherein the information packets are output through a serial bus conforming with IEEE 1394 Standard.

According to this aspect, since the information packets are output through a serial bus conforming with IEEE 1394 Standard, the information packets can output speedy.

The above object of the present invention can be achieved by an information output method. The information output method is provided with: a generating process for generating output information; an output process for generating and outputting information packets containing the generated output information and the control information used for processing the generated output information outside; and an output control process for outputting the information packets containing the fixed value information having a fixed value preset in place of the output information when the output information is not generated in the generating process.

According to the information output method, the information packets containing the fixed value information and the control information are output in place of the information packets containing the generated output information and the control information even when the output information is not generated. Thus, the same state as when the control information in the information packet is output can be maintained and sustained when the output information is not generated. When the information packets containing the output information are output again, therefore, the appropriate process for the audio information is quickly resumed at the output destination.

The above object of the present invention can be achieved by a computer data signal embodied in a carrier wave. The computer data signal represent a sequence of instructions, which executed by a computer included in an information output apparatus, the instructions cause the computer to function as: a generating device for generating output information; an output device for generating and outputting information packets containing the generated output information and the control information used for processing the generated output information outside; and an output control device for controlling the output device in such a manner as to output the information packets containing the fixed value information having a fixed value preset in place of the output information when the output information is not generated by the generating device.

According to the computer data signal, the computer reads out the computer data signal from the carrier wave and the computer functions in such a manner that the information packets containing the fixed value information and the control information are output in place of the information packets containing the generated output information and the control information even when the output information is not generated. Thus, the same state as when the control information in the information packet is output can be maintained and sustained when the output information is not generated. When the information packets containing the output information are output again, therefore, the appropriate process for the audio information is quickly resumed at the output destination.

### BRIEF DESCRIPTION OF THE DRAWINGS

FIG. 1 is a block diagram showing a general configuration of an information reproducing system according to an embodiment.

FIG. 2 is a flowchart showing the reproduction process according to an embodiment.

FIG. 3 is a timing chart showing the reproduction process according to an embodiment.

### DESCRIPTION OF THE PREFERRED EMBODIMENTS

Next, preferred embodiments of the invention will be explained with reference to the drawings

According to an embodiment of the invention described below, there is provided an information reproducing system comprising a player for reproducing the audio information recorded in an optical disk such as a DVD (digital versatile disk), a receiver for outputting (sounding) through a speaker by subjecting the audio information reproduced by the player to the amplification process and the waveform shaping process as preset, and a serial bus for connecting by wire the player and the receiver to each other in compliance with the serial bus standard.

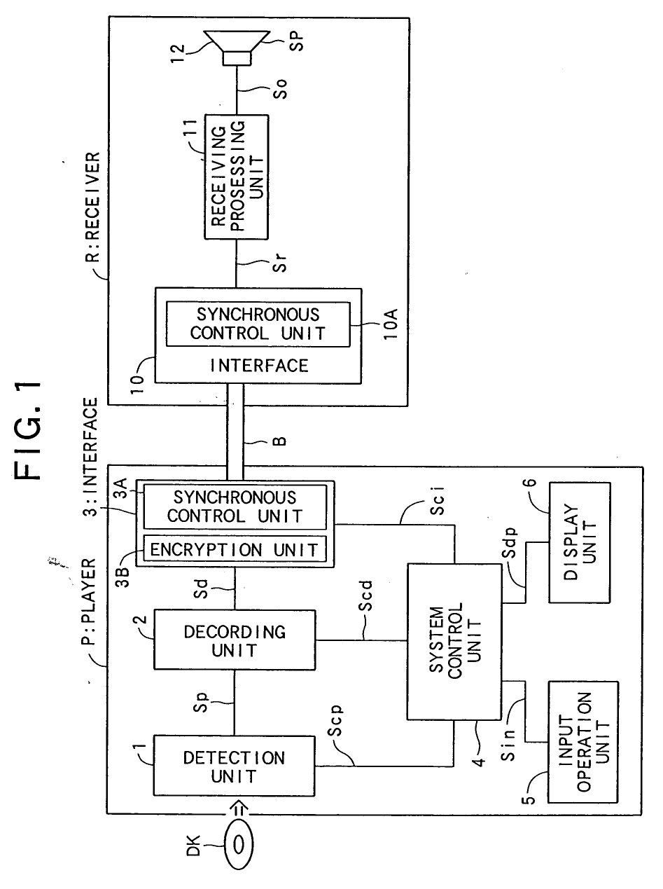

First, a general configuration of an information reproducing system according to an embodiment will be explained with reference to FIG. 1. Incidentally, FIG. 1 is a block diagram showing an outline of the configuration of the player and the receiver included in the information reproducing system according to an embodiment.

As shown in FIG. 1, the information reproducing system S according to an embodiment is configured of a player P as an information processing apparatus, a receiver R as one of other information processing apparatuses and a serial bus B for connecting the player P and the receiver R according to the serial bus standard.

The player P is configured of a detection unit 1 as a generating device, a decoding unit 2 as an acquisition device, an interface 3 as an output device including a synchronous control unit 3A and an encryption unit 3B as an encryption device, a system control unit 4 as an output control device and a prohibition device, an input operation unit 5 and a display unit 6.

On the other hand, the receiver R is configured of an interface 10 including a synchronous control unit 10A, a receiving processing unit 11 and a speaker 12.

Next, the overall operation will be explained.

First, the detection unit 1 in the player P includes a spindle motor for rotating an optical disk DK such as a DVD with audio information recorded therein, a pickup for optically detecting the audio information from the optical disk DK in rotation, and a processing unit for performing the preprocessing such as amplification preset for the detected audio information. Once the optical disk DK is loaded, the audio information recorded in the optical disk DK is optically detected under the control of the system control unit 4 using a control signal Scp, and a detection signal Sp corresponding to the detected audio information is generated and output to the decoding unit 2.

As a result, the decoding unit 2 decodes the audio information contained in the detection signal Sp under the control of the system control unit 4 using the control signal Scd, and generating the decoding information Sd, outputs it to the interface 3. In the process, the decoding unit 2 detects the copyright information which may be contained in the detection signal Sp indicating whether the particular audio information should be protected under the copyright law. This copyright information is output as a control signal Scd to the system control unit 4.

Next, the interface 3 subjects the decoding information Sd after decoding to the output interface processing based on the serial bus standard under the control of the system control unit 4 using the control signal Sci, and outputs the player output information to the receiver R through the serial bus B. In the process, the interface 3 divides the audio information contained in the decoding information Sd into isochronous packets (including the required sync information), and forming the player output information described above, sends it onto the serial bus B. Incidentally, the isochronous packet forming the player output information containing the reproduced audio information and the sync information or the like is hereinafter referred to as ‘a sounded packet’.

As described later, as long as the audio information from the optical disk DK is not reproduced, the interface 3 forms an isochronous packet using the aforementioned synchronous information or the like and the fixed value information with the value thereof fixed to ‘0’ replacing the audio information, and thus forming the player output information, outputs it to the serial bus B. The isochronous packet configured of the player output information containing the sync information or the like and the fixed value information replacing the audio information is hereinafter referred to as ‘a soundless packet’.

The encryption unit 3B in the interface 3, like the reproduction process described later, executes the process of encrypting the decoded audio information based on a predetermined encryption scheme as required and outputs the player output information described above to the serial bus B. The encryption scheme used for this purpose specifically includes the one based on what is called DTCP (digital transmission copy protection) standard which is well known as an encryption scheme for copyright protection. The detail of the DTCP standard is disclosed on the internet by DTIA (digital transmission licensing administrator) (URL is http://www.dtcp.com).

On the other hand, a series of the control operation for the player P described above is performed by the operator by way of the input operation unit 5. An operation signal Sin corresponding to the operation thus performed is generated and output to the system control unit 4.

In order to perform the overall control operation of the component members forming the player P in such a manner as to implement the process shown in the flowchart described below, the system control unit 4 generates and outputs the control signals Scp, Scd and Sci to control each component member based on the operation signal Sin.

Further, the information to be presented to the operator in the aforementioned overall control operation of the system control unit 4 is output as display information Sdp from the system control unit 4.

The display unit 6 including a liquid crystal display unit, for example, displays the aforementioned information to be presented, based on the display information Sdp.

The interface 10 of the receiver R for receiving the player output information from the interface 3, on the other hand, executes the input interface process under the serial standard against the player output information produced through the serial bus B, and outputs the receiving information Sr to the receive processing unit 11.

At the same time, the process of receiving the player output information by the interface 10 is executed with the synchronized state maintained and sustained as established using the sync information exchanged between the sync control unit 3A in the interface 3 of the player P and the sync control unit 11A in the interface 10 of the receiver R.

The receive processing unit 11 executes the receiving process as predetermined such as amplification and waveform shaping against the audio information contained in the sounded packet in the receive information Sr generated, and generating the output information So corresponding to the audio information, outputs it to the speaker 12.

As a result, the speaker 12 releases the audio information contained in the output information So as a sound.

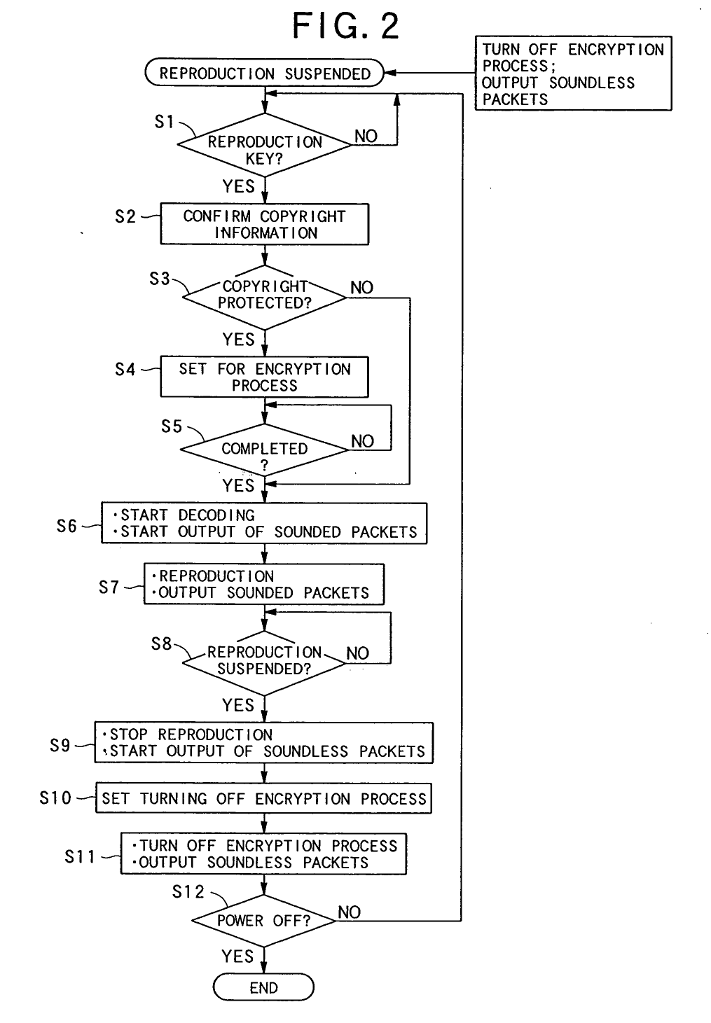

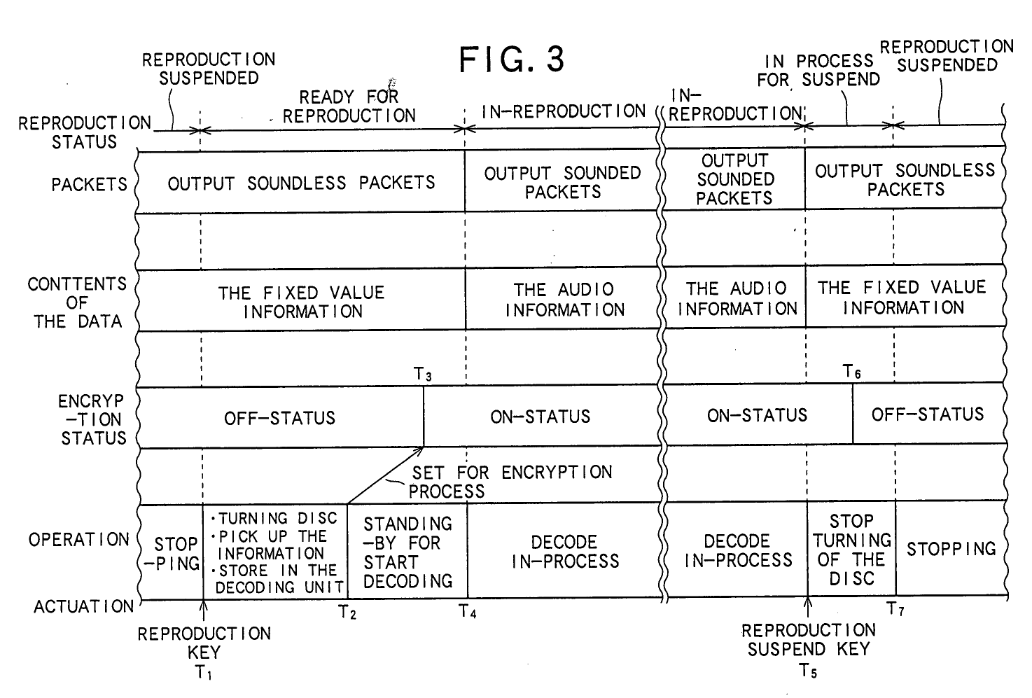

Next, the process for reproducing the audio information from the optical disk DK according to an embodiment, which is executed mainly by the player P in the information reproducing system S having the configuration and operation described above, will be explained with reference to FIGS. 2 and 3.

FIG. 2 is a flowchart showing the reproduction process, and FIG. 3 a timing chart showing the reproduction process.

As shown in FIG. 2, during the initial period of the reproduction process according to this embodiment when the process for reproducing the audio information from the optical disk DK is not executed, the soundless packet containing the fixed value information having a fixed value ‘0’ not encrypted by the encryption unit 2A is output from the interface 3 through the serial bus B to the interface 10 of the receiver R. Using the sync information in the soundless packet, the synchronized state for receiving the sounded packet is maintained between the sync control unit 3A in the interface 3 and the sync control unit 10A in the interface 10.

During the period when the reproduction process is suspended, on the other hand, the process is executed to constantly monitor whether the operation of instructing to start the reproduction of the audio information from the optical disk DK is carried out by way of the input operation unit 5 (step S1 in FIG. 2). When this operation is not carried out (NO in step S1), the process stands by until the particular operation is performed.

Assume that the operation of starting reproduction is carried out by way of the input operation unit 5, for example, at the timing T1 shown in the lowest stage of FIG. 3 (YES in step S1). The optical disk DK is rotated to the timing T2 shown in the lowest stage of FIG. 3. The control information to be read before reproduction is detected, and the decoding unit 2 of the audio information subsequently detected begins to be stored.

Also, the contents of the copyright information recorded in advance in the optical disk DK during the period to the timing T2 is confirmed by the decoding unit 2 and the system control unit 4, thereby making it possible to confirm whether the audio information to be reproduced in compliance with a reproduction command has an attribute to be protected under the copyright law (steps S2, S3 in FIG. 2).

When it is determined in step S3 that the audio information to be reproduced should be protected under the copyright law (YES in step S3), the process for setting the start of the encryption of the audio information by the encryption unit 2A is executed during the period to the timing T3 in the second lowest stage in FIG. 3 at the timing T3 (steps S4, S5 in FIG. 2). Upon completion of this setting (YES in step S5), the process for decoding the audio information detected from the optical disk DK in the decoding unit 2 and encrypting it in the encryption unit 3B are started.

During the period from the timing T2 shown in the lowest stage in FIG. 3 to the timing T4, the process stands by until the decoding process is started by the decoding unit 2. Upon starting the decoding process at the timing T4, a sounded packet containing the decoded audio information is generated and output through the serial bus B to the receiver R (steps S6, S7 in FIG. 2). At the same time, the process for encrypting the audio information in the sounded packet is executed by the encryption unit 3B. In view of the fact that the start of the encryption process is set at the timing T3, a part of the soundless packet output on the serial bus B may be encrypted during the period from timing T3 to timing T4. The encryption of the soundless packet output during the apparently short period from timing T3 to timing T4, however, poses no problem.

When it is determined in step S3 that the audio information to be reproduced requires no protection under the copyright law (NO in step S3), on the other hand, the process directly proceeds to step S6. Thus, the sounded packet containing the audio information not encrypted is generated and output to the receiver R through the serial bus B (steps S6, S7 in FIG. 2. See timing T4 and thereafter in the lowest stage in FIG. 3).

As the result of the process in steps S6 and S7, the audio information reproduced by the player P is transmitted to the receiver R and released from the speaker 12.

While the sounded packets are being output, the monitor operation is constantly carried out as to whether the operation for stopping the reproduction of the audio information from the optical disk DK has been executed or not by the input operation unit 5 (step S8 in FIG. 2). When the particular operation is not performed (NO in step S8), the sounded packets continue to be output until the particular operation is performed. When the operation for stopping the reproduction is carried out through the input operation unit 5, for example, at the timing T5 shown in the lowest stage in FIG. 3 (YES in step S8), on the other hand, the reproduction of the audio information is stopped at the timing T5 and the output is switched from the sounded packet to the soundless packet (step S9 in FIG. 2), while at the same time stopping the rotation of the optical disk DK loaded before timing T7 in the lowest stage of FIG. 3.

In parallel with these operations, the encryption process by the encryption unit 3B is stopped before the timing T6 shown in the second lowest stage of FIG. 3 (steps S10, S11 in FIG. 2). As a result, the encryption process for the fixed value information in the soundless packet is not executed. In this case, the soundless packets output on the serial bus B during the period from timing T5 to timing T6 is encrypted. No problem is posed by the soundless packets, however, if encrypted during the short period from timing T5 to timing T6.

As the result of stopping the encryption, the process proceeds to the reproduction suspended state in which only the soundless packets continue to be output.

During the reproduction suspension and thereafter, the process is always monitored as to whether the power switch not shown of the player P has been turned off or not (step 12 in FIG. 2), and when the power switch is turned off (YES in step S12), the reproduction process according to this embodiment is terminated as it is. When the power switch is not turned off (NO in step S12), on the other hand, the process returns to step S1 to repeat the series of processes described above.

As described above, with the reproduction process according to this embodiment, the soundless packets containing the fixed value information and the sync information is output in place of the sounded packets even when the audio information is not output. Thus, the same synchronized state as when the sync information in the isochronous packet is output can be maintained and sustained using the sync information contained in the soundless packets. When the sounded packets containing the audio information are output again, therefore, the receiver R can quickly resume the appropriate process for the audio information.

Also, in view of the fact that the soundless packets output with the encryption prohibited contain the fixed value information, the encryption process for the fixed value information easy to decrypt is not executed. Thus, the confidentiality of the encryption process for the audio information can be secured.

Further, since the fixed value of the fixed value information is 0, the synchronized state can be maintained through a simple process during the output of the audio information.

The embodiments described above refer to the case in which the fixed value in the fixed value information is ‘0’. Nevertheless, the fixed value information may alternatively be formed with ‘F’ in hexadecimal notation as a fixed value.

Also, unlike in the aforementioned embodiments which use the sync information in the soundless packet to maintain the synchronized state using the sync information in the isochronous packet, other control information in the soundless packet may be used to maintain the other controlled state.

This invention is applicable also to the case in which the dynamic image information containing the audio information from the optical disk DK is detected, reproduced and output to an information processing apparatus having the image display function and the audio output function at the same time.

The confidentiality of the encryption process can be further improved by employing a configuration for the operation of the encryption unit 2A of the player P in which the encryption process is prohibited not only during the suspension of reproduction of the audio information, but also during the search for the audio information to be detected on the optical disk DK, during the suspension of reproduction (‘pause’) or during the withdrawal of the disk tray not shown on which the optical disk DK is mounted.

Also, the program corresponding to the flowchart of FIG. 2 may be recorded in an information recording medium such as a flexible disk or a hard disk, or recorded by being acquired through a network such as the internet, and read and executed by a general-purpose microcomputer or the like. By doing so, the particular microcomputer or the like can be rendered to perform the same function as the system control unit 4 according to an embodiment.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-276384 filed on Sep. 20, 2002 including the specification, claims, drawings and summary is incorporated herein by reference in its entirety.

What is claimed is:

1. An information output apparatus comprising;
a generating device for generating output information;
an output device for generating and outputting information packets containing the generated output information and the control information used for processing the generated output information outside; and
an output control device for controlling the output device in such a manner as to output the information packets containing the fixed value information having a fixed value preset in place of the output information when the output information is not generated by the generating device.

2. An information output apparatus according to claim 1, further comprising:
an encryption device for encrypting the output information; and
a prohibition device for prohibiting the execution of the encryption process of the encryption device for the fixed value information when the output information is not generated by the generating device.

3. An information output apparatus according to claim 2, further comprising an acquisition device for acquiring the copyright information for the output information, wherein:
the encryption device encrypts the generated output information when the acquired copyright information indicates that the generated output information should be protected by the copyright.

4. An information output apparatus according to claim 1, wherein:
the output information is audio information and the fixed value of the fixed value information is zero.

5. An information output apparatus according to claim 1, wherein:
the control information is sync information used to form the synchronous state of the information packets at the output destination.

6. An information output apparatus according to claim 1, wherein:
the information packets are output through a serial bus conforming with IEEE (Institute of Electrical and Electronic Engineers) 1394 Standard.

7. An information output method comprising;
a generating process for generating output information;
an output process for generating and outputting information packets containing the generated output information and the control information used for processing the generated output information outside; and
an output control process for outputting the information packets containing the fixed value information having a fixed value preset in place of the output information when the output information is not generated in the generating process.

8. A computer data signal embodied in a carrier wave and representing a sequence of instructions, which executed by a computer included in an information output apparatus, the instructions cause the computer to function as:
a generating device for generating output information;
an output device for generating and outputting information packets containing the generated output information and the control information used for processing the generated output information outside; and
an output control device for controlling the output device in such a manner as to output the information packets containing the fixed value information having a fixed value preset in place of the output information when the output information is not generated by the generating device.
